(19) United States
(12) Patent Application Publication
(10) Pub. No.: US 2008/0105795 A1
(43) Pub. Date: May 8, 2008

(54) Cable retention feature

(75) Inventors: Mervyn J. Archer, Macomb Township, MI (US); Keijo J. Huotari, Fenton, MI (US)

Correspondence Address: WARN, HOFFMANN, MILLER & LALONE, .P.C, PO BOX 70098, ROCHESTER HILLS, MI, 48307, US

(73) Assignee: Magna International Inc., Aurora (CA)

(21) Appl. No.: 11/592,810

(22) Filed: Nov. 3, 2006

(51) Int. Cl. F16L 3/01

(52) U.S. Cl. 248/65

(57) ABSTRACT

A cable retention feature that is integrated into a front end module and formed to a desirable shape for the vehicle. The cable retention feature contains retention points that restrict the movement of the cable. The retention points are created by extensions that extend vertically from the surface of the cable retention feature which form a channel that the cable extends through. Thus, a cable is inserted between the extensions and placed into the channel. The extensions are shaped in a variety of ways, but it is preferred that the extensions on opposite sides of the channel, which also create the channel, are separated at a distance that is approximately the same as the diameter of the cable. Thus, the extensions form the retention points to restrict the movement of the cable.

### FIELD OF THE INVENTION

The present invention relates to a cable retention feature that is integrated with a front end module.

### BACKGROUND OF THE INVENTION

Many cars have a hood release system that utilizes a release cable that extends from the hood latch to the vehicle's interior. The vehicle's occupant can then pull on the cable in order to release the latching device from the hood. Thus, the hood can then be raised and allow access to the vehicle's components underneath the hood. There are two ways to install the cable that extends from the vehicle's interior to the hood latch. The first way is to install a partial cable and extend the cable to a point on the vehicle whereby a second attachment is attached to the cable in a second manufacturing step. The problem with installing the cable in this manner is that it introduces another manufacturing step which increases the manufacturing time and cost of the vehicle.

A second way of installing the cable is to install a full cable in the vehicle's interior and then when the front end module is installed the cable can be routed to the hood latch. The problem with this method is that extending the cable from the vehicle's interior to the hood release mechanism can be difficult at this late point of the vehicle's assembly due to all of the obstructions. In addition, it is sometimes necessary to use mechanical fasteners in both of the assembly methods described above. In other words, mechanical fasteners must be mounted to the front end module so that the cable can then be secured by the mechanical fasteners along the front end module. This requires an additional expense for the mechanical fasteners and an additional manufacturing step to mount the fasteners to the front end module.

Therefore, it would be ideal to have a cable retention feature that can be formed to a desired shape in the front end module that would allow for a full length cable installation in a single manufacturing step. Thus, it would be desirable to have a cable retention feature with retention points that are integrated with the cable retention feature to allow for easier installation of the cable.

### SUMMARY OF THE INVENTION

The present invention relates to a cable retention feature that is integrated into a front end module and formed to a desirable shape for the vehicle. The cable retention feature contains retention points that restrict the movement of the cable. The retention points are created by extensions that extend vertically from the surface of the cable retention feature which form a channel that the cable extends through. Thus, a cable is inserted between the extensions and placed into the channel. The extensions are shaped in a variety of ways, but it is preferred that the extensions on opposite sides of the channel, which also create the channel, are separated at a distance that is approximately the same as the diameter of the cable. Thus, the extensions form the retention points to restrict the movement of the cable.

The cable retention feature is formed into a variety of shapes in order to accommodate the vehicle. Thus, the channel is at a variety of heights in order to accommodate the extension path of the cable. Furthermore, the cable retention feature can be shaped in order to allow easy installation of a cable.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of the front end module with a cable retention feature;

FIG. 2A is a cross-sectional view across the line 2A-2A in FIG. 1 depicting a first extension;

FIG. 2B is a cross-sectional view across the line 2B-2B in FIG. 1 depicting a second extension;

FIG. 2C is a cross-sectional view across the line 2C-2C in FIG. 1 depicting a third extension;

FIG. 3 is a perspective view of an alternate embodiment of the cable retention feature in accordance with the present invention;

FIG. 4A is a cross-sectional view across the line 4A-4A in FIG. 3 depicting a cavity; and

FIG. 4B is a cross-sectional view across the line 4B-4B in FIG. 3 depicting a wall and an extension.

### DETAILED DESCRIPTION OF THE PREFERRED EMBODIMENTS

The following description of the preferred embodiment(s) is merely exemplary in nature and is in no way intended to limit the invention, its application, or uses.

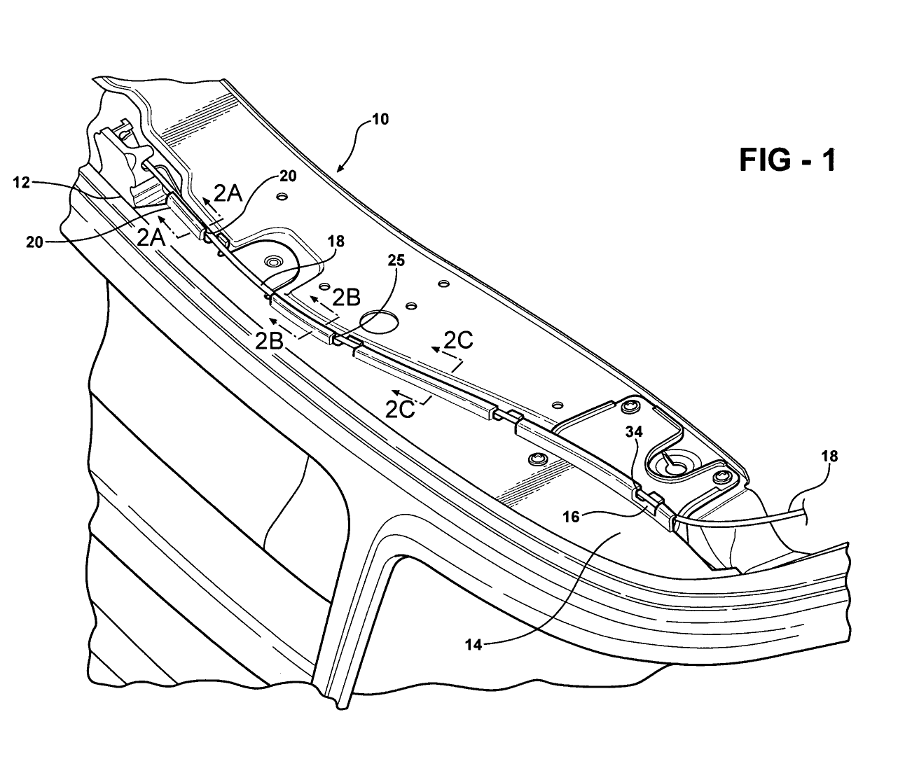

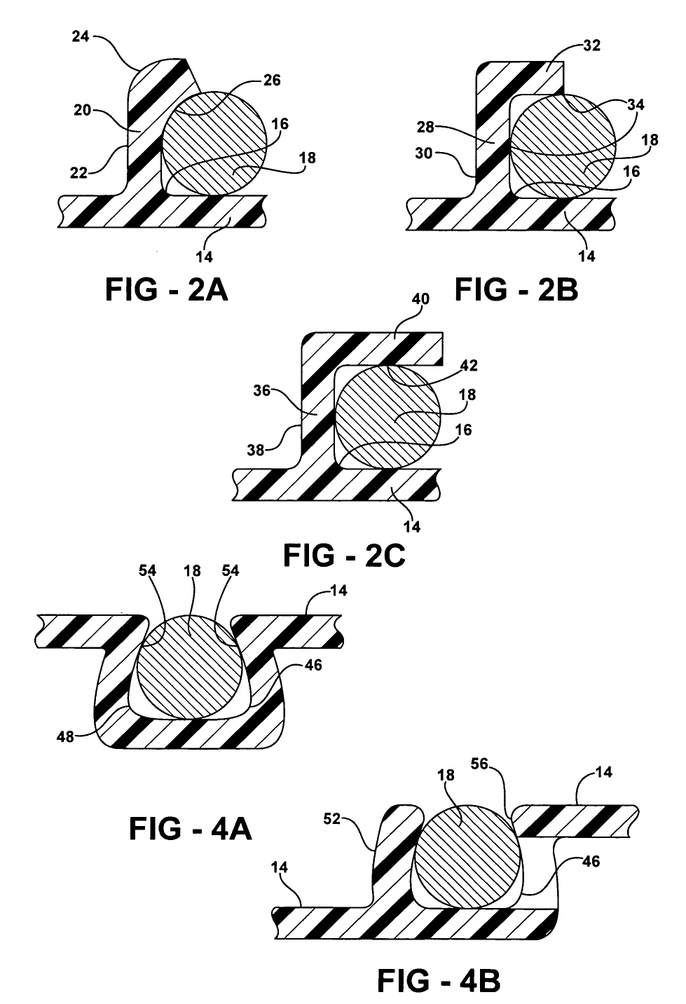

Referring to FIGS. 1-2c, a cable retention device is generally shown at 10. The cable retention device 10 comprises a body or a front end module 12 and at least one extension that extends from the surface 14. The extensions have a variety of shapes and sizes, which is described in greater detail below, and are integrated into the front end module 12. The extensions are aligned along the surface 14 in such a way as to create a channel 16 in which a cable 18 extends along the channel 16 adjacent to extensions.

Referring to FIGS. 1 and 2a, a first extension 20 has an arcuate shape as the first extension 20 extends from the surface 14. Thus, a base 22 on the first extension 20 extends substantially vertical from the surface 14, while a top portion 24 of the first extension 20 curves towards the channel 16. The curvature of the top 24 begins at a height about the same as the diameter of a cable 18 so that the top 24 extends at least partially over the cable 18 when the cable 18 and the channel 16 are adjacent the first extension 20. Typically, the top 24 extends partially over the cable 18 and not entirely over the cable 18 so that the cable 18 is retained by the first extension 20, but the cable 18 can still be placed adjacent the first extension 20. At least one retention point 26 is created by the first extension 20, in which the retention point 26 contacts the cable 18 and prevents the cable 18 from moving at undesirable times. The retention point 26 is created by the top 24, where the distance between the top 24 and the channel 16 is smaller than the diameter of the cable 18.

Referring to FIGS. 1 and 2b, a second extension 28 extends from the surface 14. The second extension 28 has a base 30 that extends substantially vertical from the surface 14. A top 32 of the second extension 28 extends substantially perpendicular to the base 30. The top 32 extends from the base 30 at a height that is about the same as the diameter of the cable 18. Typically, the top 32 extends at least partially over the channel 16 and cable 18. Thus, at least one multiple retention point 34 is created where the cable 18 contacts the top 32 while adjacent the second extension 28. The retention point 34 prevents the cable 18 from moving at undesirable times when the cable 18 is placed at the channel 16 adjacent the second extension 28. The retention point 24 is created by the distance between the channel 16 and top 32 being smaller than the diameter of the cable 18.

Referring to FIGS. 1 and 2c, a third extension 36 extends from the surface 14. The third extension 36 has a base 38 that extends substantially vertical from the surface 14. Also, the third extension 36 has a top 40 that extends substantially perpendicular from the base 38. Typically, the top 40 extends completely over the cable 18 as the cable 18 extends along the channel 16. The top 40 extends perpendicular from the base 38 at a height that is about the same as the diameter of the cable 18. Thus, a retention point 42 is created where the top 40 contacts the cable 18. Similar to above, retention point 42 prevents the cable 18 from moving at undesirable times as the cable 18 extends along the channel 16 adjacent the third extension 36. Likewise, the retention point 42 is created by the distance between the channel 16 and the top 40 being smaller than the diameter of the cable 18.

Referring to FIGS. 1-2c, placing a combination of extensions 20, 28, 36 along the surface 14 creates the channel 16 in which the cable 18 extends along. Typically, the width of the channel 16 is about the same as the diameter of the cable 18. By having the channel 16 approximately the same diameter as the cable 18, the retention points 26, 34, 42 are more effective because the cable 18 contacts the extension 20, 28, 36 as the cable 18 extends along the channel 16. In addition, the retention points 26, 34, 42 are places on the extensions 20, 28, 36 which are slightly smaller than the diameter of the cable 18. Thus, when the cable 18 is placed adjacent the retention points 26, 34, 42 the cable 18 is more securely held by the extensions 20, 28, 36.

In a preferred embodiment, a combination of the first extension 20, second extension 28, and third extension 36 is used to create the channel 16. By using a combination of the extensions 20, 28, 36 the cable 18 is more secured at some locations and more easily moved at others. For example, the first extension 20 is used at certain locations due to the cable 18 being more easily moved when adjacent the first extension 20. Also, the cable 18 is more easily placed adjacent to the first extension 20 due to the top 24 extending over less of the channel 16. By contrast, the third extension 36 more securely contains the cable 18 due to the top 40 extending completely over the channel 16 and cable 18. However, it is more difficult to place the cable 18 adjacent the first extension 20. The second extension 28 is a combination of the first extension 20 and third extension 36, such that the top 32 only partially extends over the channel 16 which secures the cable 18 more than the first extension 20, but the cable 18 is placed in the channel 16 more easily than when the cable 18 is placed adjacent the third extension 36. Thus, the number of extensions 20, 34, 36 and locations of the extensions 20, 34, 36 is dependent upon the length and shape of the channel 16.

In addition, the order or placement of the extensions 20, 34, 36 is dependent upon the above described shapes of the extensions 20, 34, 36. For example, it is preferred that the first extension 20 is used at the ends of the channel 16 to allow the cable 18 to move more easily. Thus, the cable 18 is more easily displaced when it is moved to perform a function, when compared to the third extension 36 being placed at the ends of the channel 16. Also, it is preferred that the third extension 36 is used in the middle portion of the channel 16 to more securely hold the cable 18, since movement of the cable 18 in the middle portion of the channel 16 is undesirable.

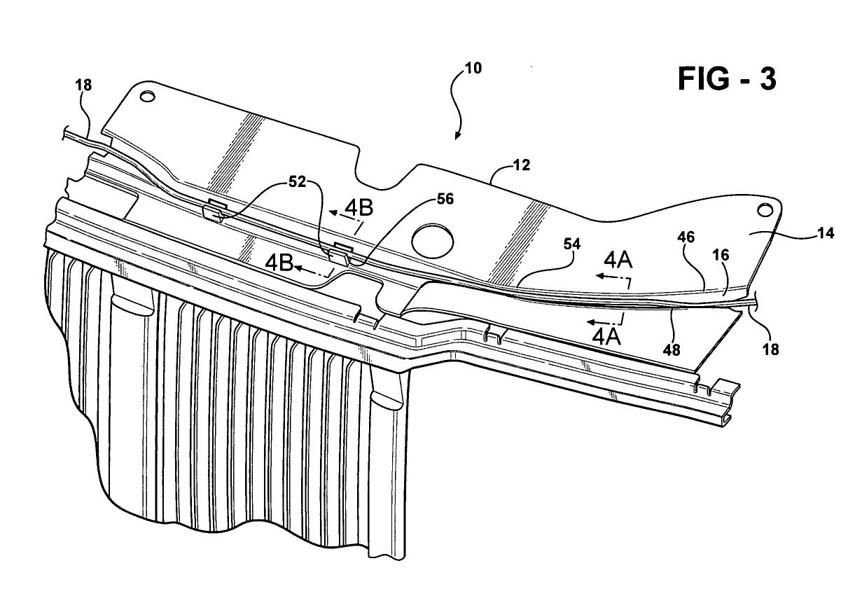

Referring to FIG. 3 and 4a, an alternate embodiment is shown where the channel 16 is at a lower height than the surface 14, thus creating a cavity 44. The cavity 44 has at least one wall 46 which forms the channel 16. Furthermore, the cavity 44 has a second wall 48 which is on the opposite side of the channel 16 than the first wall 46. Typically, the walls 46, 48 create at least one retention point 50 which secures the cable 18 and prevents the cable 18 from moving at undesirable times. The retention point 50 is created by a point along the walls 46, 48, where the distance between the first wall 46 and second wall 48 is smaller than the diameter of the cable 18. On either side of the retention point 50, the first wall 46 and second wall 48 expand so that the width of the channel 16 returns to a width that is slightly larger than the cable 18. Thus, the cable 18 is capable of moving in the channel 16, but is secured at the retention point 50 in order to prevent the cable 18 from moving at undesirable times.

Referring to FIGS. 3 and 4b, the cavity 44 has the first wall 46 and an extension 52 on the opposite side of the channel 16 as the first wall 46. Thus, the extension 52 extends substantially vertical from the surface 14 so that the channel 16 is substantially similar to the diameter of the cable 18. As described above, the extension 52 and first wall 46 create a retention point 54 where the distance between the first wall 46 and the extension 52 is smaller than the diameter of the cable 18 in order for the first wall 46 and extension 52 to securely retain the cable 18 and prevent the cable 18 from moving at undesirable times. It is also within the scope of the present invention for extension 52 to have a similar shape as the extensions 20, 28, 36 as described above, or for extension 52 to be used in combination with the first wall 46 and the extensions 20, 28, 36.

Referring to FIGS. 1-4b, the cable retention device 10 is formed to any shape in order to accommodate the cable 18. Thus, the extensions 20, 28, 36, 52 and/or the walls 46, 48 are arranged in any manner on the surface 14 in order to create the most accessible path for the cable 18. The arrangement of the extensions 20, 28, 36, 52 and/or the walls 46, 48 are dependent upon the particular vehicle and the body or front end module 12 the cable 18 is extending along.

In addition, it is within the scope of the present invention that the cable retention device 10 is integrated on different components besides the body and front end module 12. For example, but not limited to, the cable retention device 10 is integrated on a grill, close out, carrier, upper cross member, grill support, or another component in the vehicle.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A cable retention mechanism comprising:
a body;
at least one extension, wherein said at least one extension-extends from said body creating a channel; and
a cable extending along said channel adjacent said at least one extension.

2. The cable retention mechanism of claim 1 further comprising at least one retention point, wherein a first retention point is where the distance between a top of said extension and said channel is smaller than a diameter of said cable.

3. The cable retention mechanism of claim 2, wherein a first extension is on an opposite side of said channel as a second extension, and a second retention point is formed by said first extension and said second extension where the distance between said first extension and said second extension is smaller than said diameter of said cable.

4. The cable retention mechanism of claim 1, wherein a plurality of extensions align along said body in order to form said channel so that an end of said extensions align with a beginning of adjacent said extensions in order for said cable to extend along said channel, adjacent said extensions.

5. The cable retention mechanism of claim 1, wherein said extensions extend from said body on both sides of said channel.

6. The cable retention mechanism of claim 1, wherein said extensions vary in length.

7. The cable retention mechanism of claim 1, wherein said channel is at a greater height than the remaining portion of said body.

8. The cable retention mechanism of claim 1, wherein said channel is at a lower height than the remaining portion of said body creating a cavity having at least one wall, and said cable extends along said channel is said cavity adjacent said at least one wall.

9. The cable retention mechanism of claim 1, wherein said body is at least one of a front end module, a grill, a closeout, a carrier, an upper cross member, and a grill support.

10. A cable retention mechanism comprising:
a body;
a plurality of extensions, wherein said at least one extension extends from said body creating a channel;
a cable extending along said channel adjacent said at least one extension; and
at least one retention point, wherein a first retention point is where the distance between a top of said plurality of extensions and said channel is smaller than a diameter of said cable.

11. The cable retention mechanism of claim 10, wherein a first extension is on an opposite side of said channel as a second extension, and a second retention point is formed by said first extension and said second extension where the distance between said first extension and said second extension is smaller than said diameter of said cable.

12. The cable retention mechanism of claim 10, wherein said plurality of extensions align along said body in order to form said channel so that an end of said extensions align with a beginning of adjacent said extensions in order for said cable to extend along said channel, adjacent said extensions.

13. The cable retention mechanism of claim 10, wherein said extensions extend from said body on both sides of said channel.

14. The cable retention mechanism of claim 10, wherein said extensions vary in length.

15. The cable retention mechanism of claim 10, wherein said body is at least one of a front end module, a grill, a closeout, a carrier, an upper cross member, and a grill support.

16. A cable retention mechanism comprising:
a body;
at least one wall, wherein said at least one wall extends from said body creating a cavity;
a channel, wherein said channel extends along said cavity; and
a cable extending along said channel, adjacent said at least one wall.

17. The cable retention mechanism of claim 16 further comprising at least one retention point, wherein a first retention point is where the distance between a first wall on a first side of said channel and a second wall on a second side of said channel is smaller than the diameter of said cable.

18. The cable retention mechanism of claim 17, wherein a second retention point is where the distance between said first wall and at least one extension on the opposite side of said channel is smaller than the diameter of said cable.

19. The cable retention mechanism of claim 18, wherein said at least one extension vary in length.

20. The cable retention mechanism of claim 16, wherein said body is at least one of a front end module, a grill, a closeout, a carrier, an upper cross member, and a grill support.
